(19) United States
(12) Patent Application Publication
(10) Pub. No.: US 2020/0106787 A1
(43) Pub. Date: Apr. 2, 2020

(54) DATA MANAGEMENT OPERATING SYSTEM (DMOS) ANALYSIS SERVER FOR DETECTING AND REMEDIATING CYBERSECURITY THREATS

(71) Applicant: Global Data Sentinel, Inc., New York, NY (US)

(72) Inventors: John-Philip GALINSKI, New York, NY (US); Nigel WALKER, Newcastle upon Tyne (GB); James DEL ROSSI, Jamesport, NY (US)

(21) Appl. No.: 16/589,765

(22) Filed: Oct. 1, 2019

Related U.S. Application Data
(60) Provisional application No. 62/739,832, filed on Oct. 1, 2018.

(51) Int. Cl. H04L 29/06; G06F 9/54; G06F 21/60

(52) U.S. Cl. CPC H04L 63/1416; G06F 21/602; G06F 9/54; H04L 63/1425

(57) ABSTRACT

The present disclosure describes techniques to detect and remediate cybersecurity threats within an enterprise network. More specifically, a Data Management Operating System (DMOS) analysis server is described that is configured to detect and remediate interactions initiated by enterprise devices with data items stored within an enterprise network. The DMOS analysis server may be configured to capture, via a security client that resides on the enterprise device, datum metadata associated with a data operation initiated by the enterprise device, analyze the datum metadata to determine whether the data operation is associated with a cybersecurity threat, and in doing so facilitate an execution of the data operation. In some examples, the DMOS analysis server may generate a response protocol for delivery to a global key server to facilitate execution of the data operation or restrict access to the data item by the enterprise device.

### RELATED APPLICATION

This application claims priority to a co-pending, commonly owned U.S. Provisional Patent Application No. 62/739,832, filed on Oct. 1, 2018, and titled “Data Management Operating System and Techniques,” which is herein incorporated by reference in its entirety.

### BACKGROUND

The threat of cybersecurity attack is a clear and present danger to governments, enterprises and consumer end-users alike. Technology hosted on computer networks, including the Internet, is exponentiating. However, this potential will not be fully realized if it is not trusted. When users access a computer network, they are mindful, or at least should be mindful, of the threat of losing property or identity, or having their computers infected with malware, or worse, ransomware. According to Lexis Nexis, in 2009, U.S. merchants lost $190 Billion in credit card theft, most of it in online breaches. Rather than becoming an efficient and quick way to perform commerce, computer networks could be seen instead as an efficient and quick way to commit robbery.

Presently there are antivirus tools and generally software to detect breaches, but such tools are reactive and must be updated constantly as new classes of attacks are detected. Other tools attempt to predict whether a cybersecurity attack is likely, but such tools rely on past data, most of which is based on detecting that an attack, as a whole, occurred, rather than on fine-grained indicia of events. In other words, present tools can say that telecommunications systems are likely to be attacked, but not much about fine-grained leading indicators.

Accordingly, it is imperative that computer networks, private and public alike be secured as to engender trust. Otherwise, people may substantively limit the use of computer networks and not realize the benefits of one of the most major innovation drivers of our day.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a schematic view of a computing environment for operations of the Data Management Operating System.

FIG. 2 illustrates a block diagram of a process for monitoring and selectively permitting interaction with a data item stored within an enterprise network 100.

FIG. 3 illustrates a block diagram of various components of a Data Management Operating System (DMOS) for detecting and remediating cybersecurity threats.

FIG. 4 illustrates a block diagram of various components of an enterprise device operating with an enterprise network associated with the DMOS.

FIG. 5 illustrates a process for determining whether a data operation initiated at an enterprise device is indicative of typical or atypical data access usage.

FIG. 6 illustrates a process for determining whether a data operation initiated at an enterprise device is part of a cybersecurity threat.

FIG. 7 illustrates a process for generating a response protocol for a cybersecurity threat impacting an enterprise network.

FIG. 8 illustrates a process for inferring a cybersecurity threat based on a consensus of data operation(s) associated with a data item.

FIG. 9 illustrates a process for generating a cybersecurity threat data model for the analysis of datum metadata of data operation(s) executed at an enterprise device.

### DETAILED DESCRIPTION

This disclosure describes techniques to detect and remediate cybersecurity threats within an enterprise network. More specifically, a Data Management Operating System (DMOS) analysis server is described that is configured to detect and remediate interactions initiated by enterprise devices with data items stored within an enterprise network.

In the illustrated example, the DMOS analysis server is configured to protect and control access to data item(s) stored within an enterprise network. In one example, the DMOS analysis server may analyze multidimensional interactions (metadata, enterprise device, user as well as but not limited to geographic and temporal factors) between an enterprise device and data items within an enterprise network that are typical interactions or atypical interactions. A typical interaction between an enterprise device and a data item within the enterprise network may correspond to an expected behavior based on a pattern of historical behavior. In one non-limiting example, a system backup performed at 2 am on a nightly basis is an expected behavior if historically system backups occur at that same time and frequency. Thus, this interaction may be determined as typical. In contrast, a system backup performed during workday hours (i.e. 9 am to 5 pm) may correspond to an unexpected behavior if historically, system backups occur at 2 am. Thus, the latter interaction may be determined as atypical. In another non-limiting example, consider a user-specific activity, such as a team schedule review or status report submission, that occurs at substantially the same time and frequency. Thus, a user-specific activity that conforms in nature, timing (within a predetermined interval variance) and frequency relative to historically expected behavior of the team schedule review or status report submission may be determined as typical. In contrast, a user-specific activity that is different in nature (i.e. revising the team schedule rather than reviewing the team schedule) or occurs at a different time may correspond to an unexpected behavior, and thus be determined as atypical.

A typical or atypical interaction between an enterprise device and a data item within the enterprise network may be determined based on analysis of interactions between an enterprise device and data items relative to a set of heuristic behavior curves. The set of heuristic behavior curves may reflect i) historical interactions of an enterprise device, or a user and associated enterprise device, with a set of data items, ii) historical interactions of a data item with a set of enterprise devices/users, or iii) a combination of both.

The DMOS analysis server may capture substantially all interactions, including typical and atypical interactions, initiated at an enterprise device by receiving datum metadata from a security client that resides on the enterprise device. The security client may be configured to generate datum metadata in response to a user interaction or enterprise device interaction with data items stored within a data repository server of the enterprise network. More specifically, the security client may intercept Application Programming Interface (API) calls or system calls intended to create, read, update, delete, modify metadata of, or change access privileges of data items stored within the enterprise network. Further, the datum metadata may include information describing the data operation. The data operation may comprise an API call or system call to create, read, update, or delete a data item stored within the enterprise network.

In various examples, the DMOS analysis server may flag atypical interactions as potentially suspect and may notify an administrator of the enterprise network of the occurrence with a recommendation to further investigate. Additionally, the DMOS analysis server may trigger an additional analysis to determine whether the interaction between the enterprise device and data items is part of a cybersecurity threat, such as an inference attack or an aggregation attack. In this latter example, the DMOS analysis server may analyze the datum metadata relative to a dataset of known cybersecurity threats while maintaining a zero-knowledge position regarding the content of the datum. In response to identifying data patterns between the datum metadata and the dataset of known cybersecurity threats, the DMOS analysis server may infer that a cybersecurity threat affects the enterprise network, and in doing so, select a response protocol to quarantine and remediate the potential threat.

Data items, as defined within this disclosure, may include data files, data objects, data records, or access privileges associated with the same. Data items may also include multimedia streams, control messages, signal data, or computer-executable instructions intended for another enterprise device or a server within the enterprise network. The data items may represent all, or substantially all data items associated with the enterprise network and may be stored within a data repository in an encrypted state. The DMOS analysis server may be communicatively connected to a global or local relevant key server and a data repository server, each of which resides in disparate servers, for the purpose of protecting the integrity and confidentiality of encrypted data items.

The term “access” as used to describe an operation to a data item stored within the DMOS repository, is intended to collectively describe any data operation, such as a create, read, write, update, or delete operation, that is to be performed to the data item.

Further, the term “techniques,” as used herein, may refer to system(s), method(s), computer-readable instruction(s), module(s), algorithms, hardware logic, and/or operation(s) as permitted by the context described above and through the document.

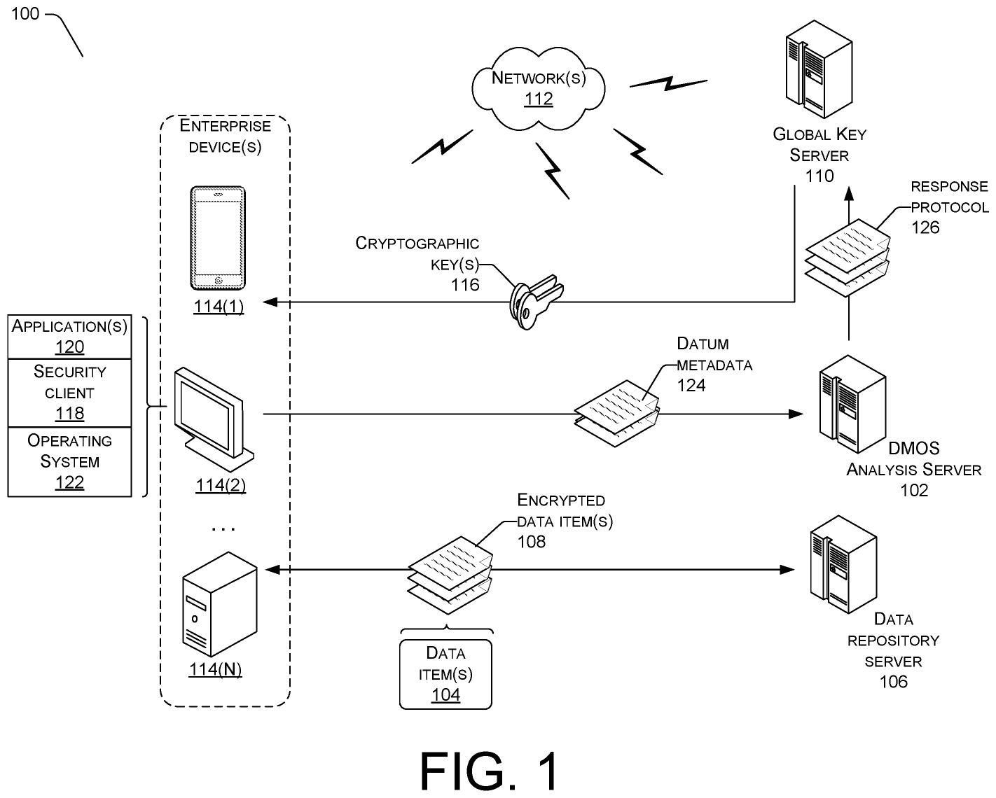

FIG. 1 illustrates a schematic view of an enterprise network 100 that is configured to support operations of the Data Management Operating System (DMOS) analysis server 102. In the illustrated example, the DMOS analysis server 102 may be configured to protect and control access to data item(s) 104 stored within an enterprise network 100. The data item(s) 104 may include data files, data objects, data records, or an access privilege associated with the same. Data items may also include multimedia streams, control messages, signal data, or computer-executable instructions intended for another enterprise device or a server within the enterprise network. The data item(s) 104 may represent substantially all data items associated with the enterprise network 100 and may be stored within a data repository server 106 in an encrypted state, as encrypted data item(s) 108.

In the illustrated example, the DMOS analysis server 102 may be communicatively connected to a global key server 110 via one or more network(s) 112. The global key server 110 may be configured to control access privileges for encrypted data item(s) 108 stored within the data repository server 106. More specifically, the global key server 110 may provide cryptographic key(s) 116 to enterprise device(s) 114(1)-114(N) for use in encrypting and decrypting data item(s) associated with the enterprise network 100.

By way of example, the enterprise device(s) 114(1)-114(N) may encrypt one or more data item(s), at the device level, using cryptographic key(s) 116 provided by the global key server 110. The subsequent encrypted data item(s) 108 is transmitted to the data repository server 106 for storage in an encrypted form. The data repository server 106 is communicatively connected to the enterprise device(s) 114(1)-114(N) via the one or more network(s) 112. Additionally, the enterprise device(s) 114(1)-144(N) may decrypt the encrypted data item(s) 108 received from the data repository server 106 using cryptographic key(s) 116 received from the global key server 110. In this way, data item(s) used within the enterprise network 100 are stored in an encrypted form within the data repository server 106, and the acts of encrypting and decrypting the encrypted data item(s) 108 are performed at the enterprise device(s) 114(1)-144(N), albeit facilitated by the cryptographic key(s) 116 provided by the global key server 110.

By way of example, the cryptographic key(s) 116 may be derived from a key management system employing best practices for key generation. The cryptographic key(s) 116 may be used to encrypt the data item(s) 104 to create the encrypted data item(s) 108, while a corresponding key pair may be used to decrypt the encrypted data item(s) 108 to access the data item(s) 104. Thus, the global key server 110 may control access privileges to data item(s) 104 within the enterprise network 100 by controlling the distribution of cryptographic key(s) 116 used for decryption. In addition to controlling access to data item(s) 104 on a per datum basis (i.e. per data item), the global key server 110 may also control access to data item(s) 104 on a per actor (i.e. per enterprise device(s) 114(1)-114(N)) level. In this latter example, the global key server 110 may create access privileges that permit a subset of enterprise device(s) 114(1)-114(N) to receive cryptographic key(s) 116 to access the data item(s) 104. In some examples, access privileges may be limited in scope, such as permitting read access to data item(s) 104, but restricting create, update, or delete access to the data item(s) 104.

The global key server 110 and the data repository server 106 may reside on separate servers such that an unauthorized access to one would not compromise the availability, integrity, or confidentiality of the encrypted data items. For example, unauthorized access of the data repository server 106 would not compromise the availability, integrity, or confidentiality of the encrypted data items, since the cryptographic key(s) 116 to decrypt the data item(s) 104 resides on a separate server, namely the global key server 110. Similarly, access to the cryptographic key(s) 116 (i.e. global key server 110) would not compromise the availability, integrity, or confidentiality of encrypted data items, since the encrypted data items reside on a separate server, namely the data repository server 106.

In the illustrated example, the enterprise device(s) 114(1)-114(N) may include a security client 118 that interfaces between application(s) 120 and an operating system 122 that reside on the enterprise device(s) 114(1)-114(N). The security client 118 may be configured to perform the encryption and decryption functions using cryptographic key(s) 116 provided by the global key server 110. The security client 118 may also be configured to detect and intercept each data operation initiated at application(s) 120 that is associated with the data item(s) 104 stored, as encrypted data item(s) 108, within the data repository server 106. In doing so, the security client 118 may generate datum metadata 124 on a per datum basis for delivery to the DMOS analysis server 102. The datum metadata 124 may include information describing the data operation. The data operation may include as an API call or system call to create, read, update, or delete a data item stored within the enterprise network 100. The datum metadata 124 may also include a user identifier of a user interacting with the enterprise device(s) 114(1)-114(N), a geolocation of the enterprise device(s) 114(1)-114(N) at a point in time that a data operation is detected, or a network segment identifier of the enterprise network 100 from which the enterprise device(s) 114(1)-114(N) initiated the interaction (i.e. data operation) with the data item(s) 104.

The DMOS analysis server 102 may receive the datum metadata 124 from the enterprise device(s) 114(1)-114(N), and in doing so, perform an analysis to infer whether a data operation associated with data item(s) 104 constitutes a cybersecurity threat. In the event that a cybersecurity threat is inferred, the DMOS analysis server 102 may generate and deliver a response protocol 126 to the global key server 110 to control the impact of the cybersecurity threat. In one example, the DMOS analysis server 102 may generate a response protocol 126 that acts to modify access privileges of cryptographic key(s) 116 stored within the global key server 110 for the purpose of restricting access to data item(s) 104 stored within the data repository server 106. The response protocol 126 may be configured to modify access privileges associated with individual data item(s) 104, or individual user(s) of enterprise device(s) 114(1)-114(N). Alternatively, or additionally, the response protocol 126 may modify access privileges with a subset of enterprise device(s) 114(1)-114(N) that are associated with a segment of the enterprise network 100.

Additionally, the response protocol 126 may further include a message for delivery to an administrator of the enterprise network 100. The message may describe the inferred cybersecurity threat and a recommendation for implementation of one or more remedial actions.

In the illustrated example, the DMOS analysis server 102 may interact with enterprise device(s) 114(1)-114(N) via one or more network(s) 112. The enterprise device(s) 114(1)-114(N) may correspond to any sort of electronic device, such as an Internet-of-Things (IoT) device, a cellular phone, a smartphone, a tablet computer, an electronic reader, a media player, a gaming device, a personal computer (PC, a laptop computer), etc. The enterprise device(s) 114(1)-114(N) may have a subscriber identity module (SIM), such as an eSIM, to identify the respective electronic device to a telecommunications service provider network (also referred to herein as “telecommunications network”).

The DMOS analysis server 102, the global key server 110, and the data repository server 106 may each operate on one or more distributed computing resource(s). The one or more distributed computing resource(s) may include one or more computing device(s) that operate in a cluster or other configuration to share resources, balance load, increase performance, provide fail-over support or redundancy, or for other purposes. The one or more computing device(s) may include one or more interfaces to enable communications with other networked devices, such as enterprise device(s) 114(1)-114(N) via one or more network(s) 112.

The one or more network(s) 112 may include public networks such as the Internet, private networks such as an institutional and/or personal intranet, or some combination of private and public networks. The one or more network(s) can also include any type of wired and/or wireless network, including but not limited to local area network (LANs), wide area networks (WANs), satellite networks, cable networks, Wi-Fi networks, Wi-Max networks, mobile communications networks (e.g. 3G, 4G, LTE, 5G NR-LTE, and so forth), or any combination thereof.

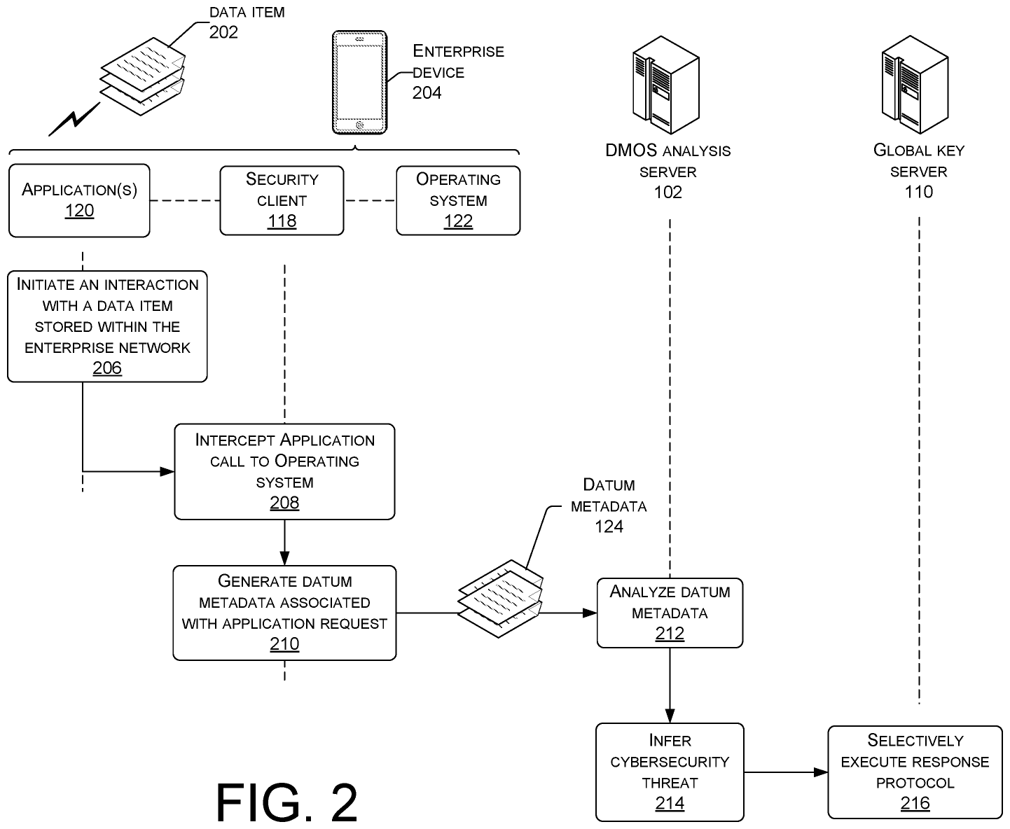

FIG. 2 illustrates a block diagram of a process 200 for monitoring and selectively permitting an interaction with a data item 202 stored within an enterprise network 100. The data item 202 may correspond to data item(s) 104, which is an unencrypted form of encrypted data item(s) 108. Process 200 may be initiated at an enterprise device 204, which corresponds to one of enterprise device(s) 114(1)-114(N). The enterprise device 204 may retain privileged access to the enterprise network 100 and the data item 202 stored therein. A DMOS analysis server 102 associated with the enterprise network 100 may be configured to detect and intercept an intended interaction between the enterprise device 204 and the data item 202. The DMOS analysis server 102 may analyze the datum metadata 124 associated with the intended interaction and determine whether the intended interaction initiated at the enterprise device 204 poses a cybersecurity threat to the enterprise network 100.

Referring to FIG. 2, at block 206, an enterprise device 204 may initiate an interaction with the data item 202 stored within the enterprise network 100. The interaction may be initiated via one or more application(s) that reside on the enterprise device 204. Each interaction may constitute a data operation that calls the data item 202, such as an API call or a system call. In some examples, the data operation may comprise a request to create, read, update, or delete (i.e. CRUD) the data item 202.

At block 208, a security client 118 that resides on the enterprise device 204 may detect and intercept each data operation associated on a data item. At block 210, the security client 118 may generate datum metadata 124 on a per datum basis. The datum metadata may include information describing the data operation, such as an API call or system call. The datum metadata 124 may include additional information associated with the enterprise device 204, such as, but not limited to, a user identifier of a user interacting with the enterprise device 204, a geolocation of the enterprise device 204 at a point in time that a data operation is detected, or a network segment identifier of the enterprise network 100 from which the enterprise device 204 initiated the interaction (i.e. data operation) with the data item.

It is noteworthy that the datum metadata 124 does not describe the content of the data item 202. Instead, the datum metadata 124 describes interactions initiated at the enterprise device 204 that are associated with the data item 202 stored within the enterprise network 100. Thus, the confidentiality and security of content associated with the data item 202 is not compromised by relaying the datum metadata 124 between the security client 118 at the enterprise device 204 and the DMOS analysis server 102.

In one example, the datum metadata 124 may describe a single data operation associated with a data item, such as an API call or a system call. Alternatively, the datum metadata 124 may correspond to an aggregate of data operations, such as a combination of API calls and system calls, each of which occurs simultaneously or near-simultaneously.

At block 212, the DMOS analysis server 102 may analyze the datum metadata 124 to determine whether the enterprise device 204 interaction with the data item 202 may be part of a cybersecurity threat. In a first example, the DMOS analysis server 102 may employ one or more trained machine learning algorithms to perform a heuristic behavior analysis. The heuristic behavior analysis may comprise correlating the datum metadata 124 with a set of heuristic behavior curves that represent typical interactions between the enterprise device 204 on a per datum basis (i.e. per data item 202) within the enterprise network 100.

By comparing datum metadata 124 to a set of heuristic behavior curves, the DMOS analysis server 102 may determine whether a current data operation involving the data item 202 is a legitimate, typical data operation. Similarly, an inconsistency between the datum metadata 124 and the set of heuristic behavior curves may reflect an atypical data operation indicative of a cybersecurity threat. By way of example, consider an enterprise that periodically conducts a system backup. If on one occasion, the system backup was performed in an unexpected manner or generated unexpected results, the DMOS analysis server 102 may quantify the irregularity as a departure of datum metadata 124 from the set of heuristic behavior curves.

In another example, the DMOS analysis server 102 may employ one or more trained machine-learning algorithms to perform a cybersecurity threat analysis. The cybersecurity threat analysis may comprise correlating the datum metadata 124 with a dataset of known cybersecurity threats. In some cases, the cybersecurity threat analysis may be triggered by the heuristic behavior analysis. For example, if the datum metadata 124 reflects an atypical data operation, the DMOS analysis server 102 may trigger an additional analysis of the datum metadata 124 relative to the dataset of known cybersecurity threats to determine whether the atypical data operation is associated with a known cybersecurity threat. Alternatively, a cybersecurity threat analysis may occur concurrently with, and independent of, the heuristic behavior analysis.

At block 214, the DMOS analysis server 102 may infer whether a data operation associated with a data item is likely related to a known cyber-attack. In one example, the DMOS analysis server 102 may base its inference of a cybersecurity threat on a security score relative to predetermined or dynamic security thresholds.

At block 216, the DMOS analysis server 102 employs various techniques to generate and execute a response protocol to address an inferred cybersecurity threat. In one example, the DMOS analysis server 102 may infer that data operation(s) associated with a data item are inconclusively suspicious, and in doing so, generate a message for delivery to an administrator of the DMOS analysis server 102 that describes the data operation(s) and rationale for inferring an association with a cybersecurity threat. The message may further include one or more selectable options to permit execution of the data operation(s) or terminate execution of the data operation(s).

In another example, the DMOS analysis server 102 may infer that data operation(s) associated with a data item are conclusively suspicious, and in doing so, dynamically, and in near/real-time, generate a response protocol, such as response protocol 126 for delivery to the global key server 110, which prevents the enterprise device 204 from locating, identifying, accessing or using the data item 202 (via encrypted data item(s) 108 ciphertext form), and which by extension, also prevents proliferation of the cybersecurity threat to other segments of the enterprise network 100 and effectively isolating the enterprise device 204.

The response protocol 126 may be configured to instruct the global key server 110 to withhold the provisioning of cryptographic key(s) 116 required to access the data item 202, effectively quarantining the data item 202 within the data repository server 106. Alternatively, the response protocol 126 may be configured to alter access privileges associated with the data item 202 to ensure that the enterprise device 204 is no longer authorized to access the data item 202. In this latter example, access privileges may be configured in such a way that administrators of the DMOS analysis server 102 retain access to the data item 202 to assess and rectify an inferred cybersecurity threat.

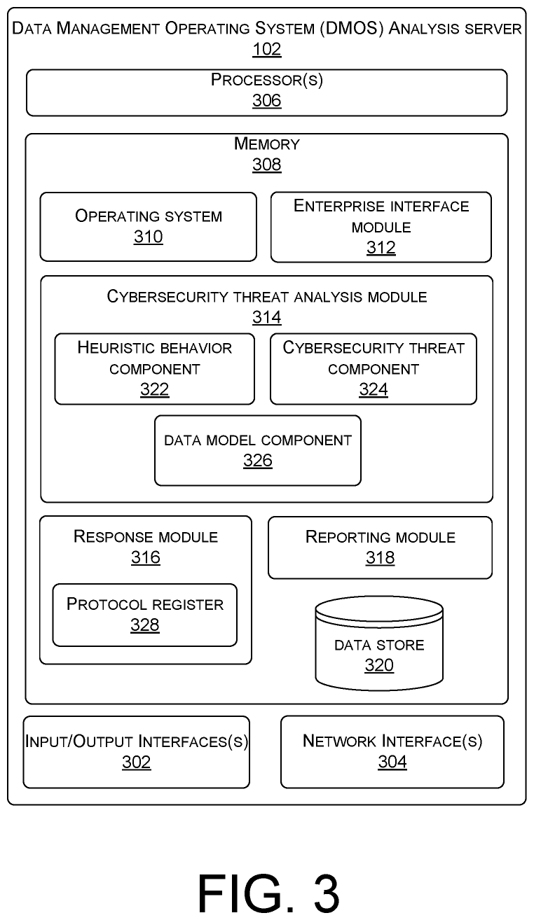

FIG. 3 illustrates a block diagram of various components of a Data Management Operating System (DMOS) analysis server for detecting and remediating cybersecurity threats. The DMOS analysis server 102 may be configured to create a set of services to manage each and every data item, track permissions, and track any and all access to data items within an enterprise network. In doing so, the DMOS may preemptively detect the deployment of a cybersecurity threat within the enterprise network based on an analysis of per datum data usage within the enterprise network relative to data patterns of known cybersecurity threats. In some instances, the DMOS may further deploy a remedial protocol to protect the enterprise network from an impending cybersecurity threat, or quarantine infected data items from a lapsed or currently deployed cybersecurity threat.

The DMOS analysis server 102 may include input/output interface(s) 302. The input/output interface(s) 302 may include any type of output interface known in the art, such as a display (e.g. a liquid crystal display), speakers, a vibrating mechanism, or a tactile feedback mechanism. Input/output interface(s) 302 also include ports for one or more peripheral devices, such as headphones, peripheral speakers, or a peripheral display. Further, the input/output interface(s) 302 may further include a camera, a microphone, a keyboard/keypad, or a touch-sensitive display. A keyboard/keypad may be a push-button numerical dialing pad (such as on a typical telecommunication device), a multi-key keyboard (such as a conventional QWERTY keyboard), or one or more other types of keys or buttons, and may also include a joystick-like controller and/or designated navigation buttons, or the like.

Additionally, the DMOS analysis server 102 may include network interface(s) 304. The network interface(s) 304 may include any sort of transceiver known in the art. For example, the network interface(s) 304 may include a radio transceiver that performs the function of transmitting and receiving radio frequency communications via an antenna. In addition, the network interface(s) 304 may also include a wireless communication transceiver and a near-field antenna for communicating over unlicensed wireless Internet Protocol (IP) networks, such as local wireless data networks and personal area networks (e.g. Bluetooth or near field communication (NFC) networks). Further, the network interface(s) 304 may include wired communication components, such as an Ethernet port or a Universal Serial Bus (USB).

Further, the DMOS analysis server 102 may include one or more processor(s) 306 that are operably connected to memory 308. In at least one example, the one or more processor(s) 306 may be a central processing unit(s) (CPU), graphics processing unit(s) (GPU), or both a CPU and GPU or any other sort of processing unit(s). Each of the one or more processor(s) 306 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution. The one or more processor(s) 306 may also be responsible for executing all computer applications stored in the memory, which can be associated with common types of volatile (RAM) and/or non-volatile (ROM) memory.

In some examples, memory 308 may include system memory, which may be volatile (such as RAM), non-volatile (such as ROM, flash memory, etc.) or some combination of the two. The memory may also include additional data storage devices (removable and/or non-removable) such as, for example, magnetic disks, optical disks, or tape.

The memory 308 may further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

In the illustrated example, the memory 308 may include an operating system 310, an enterprise interface module 312, a cybersecurity threat analysis module 314, a response module 316, a reporting module 318, and a data store 320. The operating system 310 may be any operating system capable of managing computer hardware and software resources. The operating system 310 may include an interface layer that enables applications to interface with the input/output interface(s) 302 and the network interface(s) 304.

The enterprise interface module 312 may be configured to interface with the global key server and the enterprise device(s). With regards to the global key server, the enterprise interface module 312 may communicate response protocol(s) intended to create, modify, or delete access privileges associated with the data items stored within the data repository server. Response protocol(s) may be configured to restrict access privileges to a particular data item or set of data items. Alternatively, or additionally, the response protocol(s) may restrict access privileges of a particular enterprise device, or a subset of enterprise devices.

The enterprise interface module 312 may also interface with a security client that resides on an enterprise device to receive datum metadata associated with data operations executed at the enterprise device. The data operations may comprise an API call or a system call to create, read, update, or delete a data item stored within the data repository server of the enterprise network. The data item itself may correspond to a data file, data object, data record, or an access privilege associated with the same. Data items may also include multimedia streams, control messages, signal data, or computer-executable instructions intended for another enterprise device or a server within the enterprise network.

The enterprise interface module 312 may also receive system preferences and settings from administrators of the enterprise network, security administrators, or data governance specialists. These preferences and settings, such as dynamic usage thresholds and dynamic security thresholds, may support inferences drawn from machine-learning algorithms and data model correlations performed by the cybersecurity threat analysis module 314.

The cybersecurity threat analysis module 314 may further include a heuristic behavior component 322, a cybersecurity threat component 324, and a data model component 326. The heuristic behavior component 322 may employ one or more machine learning algorithms to generate a set of heuristic behavior curves, based on historical, typical, interactions between enterprise device(s) and data items stored within the data repository server of the enterprise network. The heuristic behavior curves may be developed to reflect interactions initiated by an enterprise device, or a subset of enterprise device(s) with data items within the enterprise network. In this example, the set of heuristic behavior curves may be used to determine whether a current interaction initiated by an enterprise device, or subset of enterprise device(s), is an interaction that is typical and expected from the enterprise device, or subset of enterprise device(s).

Alternatively, or additionally, the set of heuristic behavior curves may be developed to reflect interactions directed towards a data item, or a set of data items, by enterprise devices within the enterprise network. In this example, the set of heuristic behavior curves may be used to determine whether a current interaction direct towards a data item, or set of data items, is an interaction that is typical and expected for the data item or set of data items.

Moreover, the heuristic behavior component 322 may employ one more machine-learning algorithms to correlate the datum metadata with the set of heuristic behavior curves and further assign a usage behavior score, based on the aforementioned correlation. The usage behavior score may be associated with an enterprise device that initiated the interaction (i.e. data operation) or the data item to which the interaction was directed. The one or more trained machine-learning algorithms may include, but are not limited to, supervised learning, unsupervised learning, semi-supervised learning, naive Bayes, Bayesian network decision trees, neural networks, fuzzy logical models, multiclass decision forest, and/or probabilistic classification.

Further, in a non-limiting example, the usage behavior score may be alpha-numeric (i.e. 0 to 10, or A to F), descriptive, (i.e. low, medium, or high), based on color (i.e. red, yellow, or green), or any other suitable rating scale. A high usage behavior score (i.e. 7 to 10, high, or red) may reflect an inference that the data operation is likely atypical. A medium security score (i.e. 4 to 6, medium, or yellow) may reflect an inference that a data operation is inconclusively typical or atypical. A low security score (i.e. 1 to 3, low, or green) may reflect an inference that the data operation is typical and likely part of a legitimate data operation.

The heuristic behavior component 322 may be configured to set, and continually re-set, a dynamic usage threshold to reflect changes in the development of the set of heuristic curves over a predetermined time interval. As the set of heuristic curves changes over time within the inclusion of more recent interaction metadata, so too does the dynamic usage threshold.

Moreover, the heuristic behavior component 322 may compare the usage behavior score with the dynamic usage threshold, and in doing so, transmit an indication of the same to the response module 316.

The cybersecurity threat component 324 may employ one or more trained machine-learning algorithms to generate a dataset of known cybersecurity threats. The dataset of known cybersecurity threats may be developed based on historical interactions of the enterprise network with cybersecurity threats over a predetermined time interval. Historical interactions may draw on ancillary datum metadata that describe when (i.e. time of day or day of the week) and/or where (i.e. geolocation) an enterprise device initiates an interaction with a data item stored within the data repository server. Note that the “when” and “where” may be based on the datum metadata retrieved from the security client of the enterprise device.

Additionally, or alternatively, the DMOS analysis server may import a portion of, or substantially all of the dataset of known cybersecurity threats from third-party entities that are knowledgeable in known cybersecurity threat data. In various examples, the dataset of known cybersecurity threats may describe indicators of each state (i.e. elapsed, current, or impending) of a cybersecurity threat, such that the DMOS analysis server may infer, via analysis, the presence of a cybersecurity threat within the enterprise network, irrespective of whether the cybersecurity threat has already deployed, is currently being deployed or is yet to deploy.

Moreover, the cybersecurity threat component 324 may employ one more machine-learning algorithms to correlate the datum metadata with the set of known cybersecurity threats and further assign a security score, based on the aforementioned correlation. The security score may be assigned to the enterprise device that initiated the interaction (i.e. data operation) with the data item or the data item to which the interaction was directed.

The one or more trained machine-learning algorithms may include, but are not limited to, supervised learning, unsupervised learning, semi-supervised learning, naive Bayes, Bayesian network decision trees, neural networks, fuzzy logical models, multiclass decision forest, and/or probabilistic classification.

The security score may be alpha-numeric (i.e. 0 to 10, or A to F), descriptive, (i.e. low, medium, or high), based on color (i.e. red, yellow, or green), or any other suitable rating scale. A high security score (i.e. 7 to 10, high, or red) may reflect an inference that the data operation is likely part of a cyber-attack. A medium security score (i.e. 4 to 6, medium, or yellow) may reflect an inference that the data operation may be part of cyber-attack. A low security score (i.e. 1 to 3, low, or green) may reflect an inference that the data operation is unlikely part of a cybersecurity threat and is instead part of a legitimate data operation.

The cybersecurity threat component 324 may be configured to set, and continually re-set, a dynamic security threshold to reflect changes in the development of the set of cybersecurity threats over a predetermined time interval. As the dataset of known cybersecurity threats changes over time with the inclusion of more recent cybersecurity threat data, so too does the dynamic cybersecurity threshold.

Moreover, the cybersecurity threat component 324 may compare the security score with the dynamic threshold, and in doing so, transmit an indication of the same to the response module 316.

In various examples, the data model component 326 may generate a data model based on the set of heuristic behavior curves and the dataset of known cybersecurity threats. In some examples, the cybersecurity threat component 324 may use the data model to infer cybersecurity threats based on a correlation of the datum metadata with data points of the data model. In this way, the cybersecurity threat component 324 may assign a security score that considers both a heuristic behavioral analysis and a cybersecurity threat analysis.

The response module 316 may be configured to select a response protocol from a protocol register 328 based on a comparison of the usage behavior score and/or security score relative to their respective dynamic threshold(s). The response module 316 may be configured to transmit computer-executable instructions to the global key server to withhold, or provision, cryptographic keys to decrypt data items (i.e. instances of an enterprise device reading, updating, or deleting a data item stored within the data repository server) or encrypt data items (i.e. instances of an enterprise device creating a new data item that is to be stored within the data repository server) associated with the enterprise network.

The protocol register 328 may include a list management plan of response protocols for different instances of usage behavior scores and security scores that are associated with a particular enterprise device or a particular data item. For example, the protocol register 328 may indicate that, in response to a security score being greater than or equal to a dynamic security threshold, a data item is to be quarantined from enterprise devices within the enterprise network, and an enterprise network administrator is to be notified of an inferred cybersecurity threat.

In another example, the protocol register 328 may indicate that, in response to a usage behavior score being greater than or equal to a dynamic usage threshold, an enterprise device is to be quarantined from the enterprise network, and an enterprise network administrator is to be notified of in inferred atypical behavior.

The reporting module 318 may generate reports that show a frequency of attempted cybersecurity threats, successes, and failures in detecting cybersecurity threats, and the efficacy of remedial protocols. The reporting module 318 may generate the reports based on historical transaction logs that are developed by the reporting module 318 from datum metadata retrieved from each enterprise device. The historical transaction logs may be stored within the data store 320 or a data repository server 106 that is remotely accessible by the DMOS analysis server 102.

By way of example, a report may show a statistical correlation of developed cybersecurity threat patterns relative to a current cybersecurity threat. The report may indicate that a set of developed patterns used to detect a particular cybersecurity threat produce a high number of false positives, suggesting that the developed cybersecurity threat patterns are no longer accurate. Similarly, the report may indicate that a set of developed patterns did not detect a cybersecurity threat that was later found to have been deployed, suggesting that the set of developed patterns is no longer accurate. Similarly, the report may indicate that a set of developed patterns has not been detected, nor has the corresponding cybersecurity threat been detected, suggesting that the corresponding cybersecurity threat is no longer active.

In various examples, an administrator of the DMOS may use the generated report to modify developed cybersecurity threat patterns or monitoring parameters of datum metadata at enterprise devices.

The data store 320 may be configured to store historical instances of datum metadata retrieved from enterprise device(s) within the enterprise network. The data store 320 may also include datasets of known cybersecurity threats, which may include an import of data from third-party entities that are knowledgeable in known cybersecurity threat data.

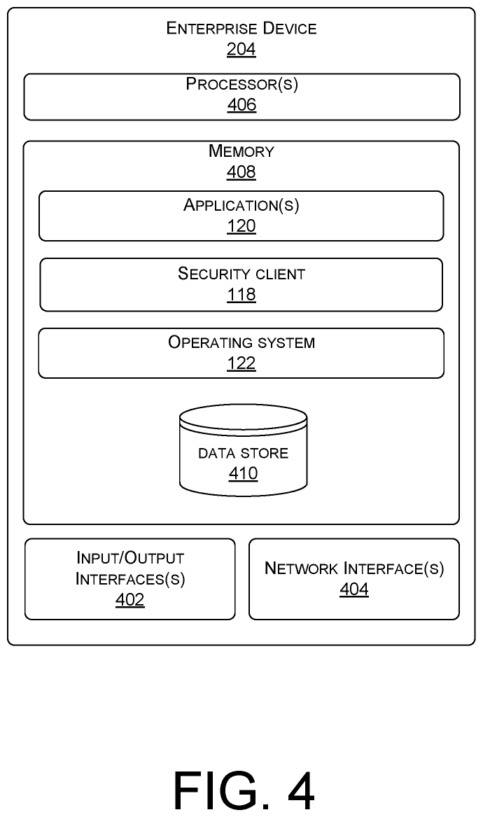

FIG. 4 illustrates a block diagram of various components of an enterprise device 204 operating with an enterprise network associated with the DMOS analysis server 102. In various examples, the DMOS analysis server 102 may be configured to detect and monitor an operation of the enterprise device 204 as it interacts with data items stored within the enterprise network (i.e. data repository server 106).

In the illustrated example, the enterprise device 204 may include input/output interface(s) 402 and network interface(s) 404. The input/output interface(s) 402 may be similar to the input/output interface(s) 302, and the network interface(s) 404 may be similar to the network interface(s) 304.

Further, the enterprise device 204 may include one or more processor(s) 406 that are operably connected to memory 408. The one or more processor(s) 406 may be similar to the one or more processor(s) 306, and the memory 408 may be similar to the memory 308.

In the illustrated example, the memory 408 may include an operating system 122, application(s) 120, a security client 118, and a data store 410. The operating system 122 may include an interface layer that enables the application(s) 120 and security client 118 to interface with the input/output interface(s) 402 and the network interface(s) 404.

The application(s) 120 may correspond to user application(s) that are configured to access and interact with data item(s) stored within the enterprise network. The application(s) 120 may initiate API calls that request access to a data item stored within a data repository server of the enterprise network or initiate a request to create a data item that is to be stored within the data repository server.

The security client 118 may be configured to detect and intercept each data operation associated with a data item. The security client 118 may generate datum metadata on a per datum basis or per user-specific interaction with the enterprise device 204. The datum metadata may include information describing the data operation, such as an API call or system call to create, read, update, or delete a data item stored within the enterprise network.

The datum metadata may include additional information associated with the enterprise device, such as, but not limited to, a user identifier of a user interacting with the enterprise device, a geolocation of the enterprise device at a point in time that a data operation is detected, or a network segment identifier of the enterprise network from which the enterprise device initiated the interaction (i.e. data operation) with the data item.

Further, the security client 118 may perform the encryption and decryption functionality for data items, using cryptographic key(s) provided to the security client 118 by the global key server. In one example, the security client 118 may use a cryptographic key to encrypt a newly created data item or encrypt an update to an existing data item, that is being stored within the data repository server. In another example, the security client 118 may use a cryptographic key to decrypt an encrypted data item retrieved from the data repository server.

The data store 410 may selectively store profile metadata (i.e. geolocations and historical transaction logs of application(s) 120 interactions) that may be incorporated into the datum metadata sent by the security client 118 to the DMOS analysis server. In various examples, the data store 410 may also store working data associated with application(s) 120, the security client 118 and the operating system 122.

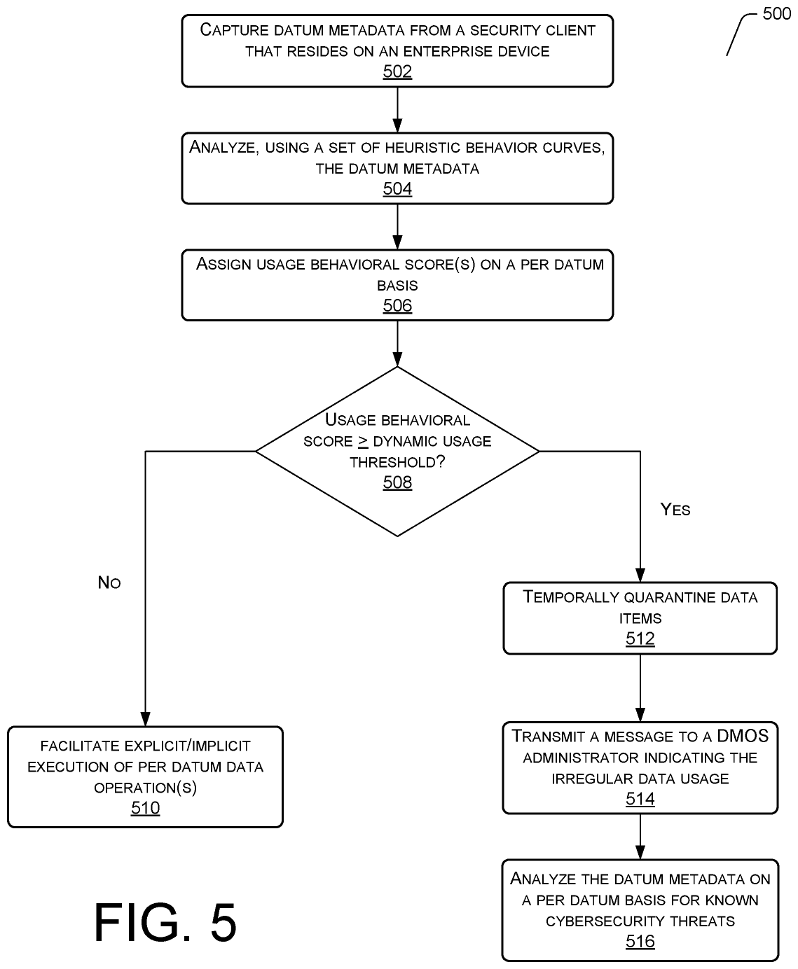

FIGS. 5 through 9 present processes 500 through 900 that relate to operations of the DMOS analysis server 102. Each of processes 500 through 900 illustrate a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 500 through 900 are described with reference to the enterprise network 100 of FIG. 1.

FIG. 5 illustrates a process for determining whether a data operation initiated at an enterprise device is indicative of typical or atypical data access usage. A typical or atypical interaction between an enterprise device and a data item within the enterprise network may be determined based on analysis of datum metadata relative to a set of heuristic behavior curves.

The set of heuristic behavior curves may be developed over a predetermined time interval based on historical, typical interactions between enterprise device(s) and data items stored within the data repository server of the enterprise network. More specifically, the set of heuristic behavior curves may reflect i) historical interactions of an enterprise device, or user, with a set of data items, ii) historical interactions of a data item with a set of enterprise devices, or iii) a combination of both.

At 502, the DMOS analysis server may capture datum metadata from a security client that resides on an enterprise device. The datum metadata may describe individual instances of data operations, on a per datum basis (i.e. data item), initiated at the enterprise device. Data operations may include individual API calls or individual system calls associated with a data item. Alternatively, the datum metadata may describe an aggregate of data operations, on a per datum basis, initiated at the enterprise device over a predetermined time interval. The predetermined time interval may be set by an administrator of the DMOS and may correspond to one minute, ten minutes, 30 minutes, or one hour. Any time interval is possible.

At 504, the DMOS analysis server may employ one or more trained machine learning algorithms to correlate the datum metadata with a set of heuristic behavior curves that represent typical interactions between an enterprise device on a per datum (i.e. per data item) basis within the enterprise network.

At 506, the DMOS analysis server may assign a usage behavior score, based on a correlation of the datum metadata 124 and the set of heuristic behavior curves. In one example, the user behavior score may be based on interactions directed towards a particular data item by one or more enterprise device(s), and therefore the usage behavior score may be assigned to the particular data item. In another example, the user behavior score may be based on interactions initiated by a particular enterprise device with one or more data items, and therefore the usage behavior score may be assigned to the particular enterprise device. The magnitude of the user behavior score is intended to reflect whether the interaction directed towards a data item or initiated by an enterprise device, is typical or atypical of historical interactions. By way of example, an atypical interaction may include an enterprise device initiating an access request to unprivileged data items, initiating the access request from atypical geolocations, at atypical times of the day or days of the week, or initiating an access request from an atypical network segment within the enterprise network.

At 508, the DMOS analysis server may determine whether the usage behavior score is greater than or equal to a dynamic usage threshold. The dynamic usage threshold may be set by an administrator of the DMOS analysis server as a function of the set of heuristic behavior curves. In other words, as the set of heuristic behavior curves develop over a predetermined time interval, so too does the dynamic usage threshold. The dynamic usage threshold may represent a usage behavior score above which the DMOS analysis server considers indicative of an atypical data operation.

At 510, the DMOS analysis server may determine that the usage behavior score is less than the dynamic usage threshold. In this instance, the DMOS analysis server may infer that the data operation is typical and likely part of a legitimate data operation. In doing so, the DMOS analysis server may facilitate an explicit/implicit execution of the data operation associated with the data item. In one example, the data item may be encrypted. Therefore, the DMOS analysis server may interact with a global key server to provision a cryptographic key to the enterprise device to decrypt and access the data item. An explicit execution may correspond to providing the cryptographic key to the enterprise device, whereas an implicit execution may correspond to not blocking an act to provide the cryptographic key to the enterprise device.

At 512, the DMOS may determine that the usage behavior score is greater than or equal to the dynamic usage threshold. Accordingly, the DMOS may infer that the data operation is an atypical data operation that may be indicative of a cybersecurity threat.

In this instance, the DMOS analysis server may generate a response protocol to temporally quarantine the data item associated with the data operation. In one example, the DMOS analysis server may generate instructions for the global key server to withhold provisioning of a cryptographic key required to decrypt the encrypted data item. Alternatively, the response protocol may instruct the global key server to alter access privileges associated with the data item to ensure that the enterprise device is no longer provisioned with a cryptographic key to access the data item. In some examples, the DMOS analysis server, or global key server, may transmit a message to the enterprise device indicating that the data item has been temporally quarantined based on an inferred cybersecurity threat.

At 514, the DMOS may generate a message for delivery to an administrator of the DMOS that describes the data operation(s) and rationale for inferring that the data operation associated with the data item may be atypical. The message may further include one or more selectable options to permit execution of the data operation(s) or terminate execution of the data operation(s).

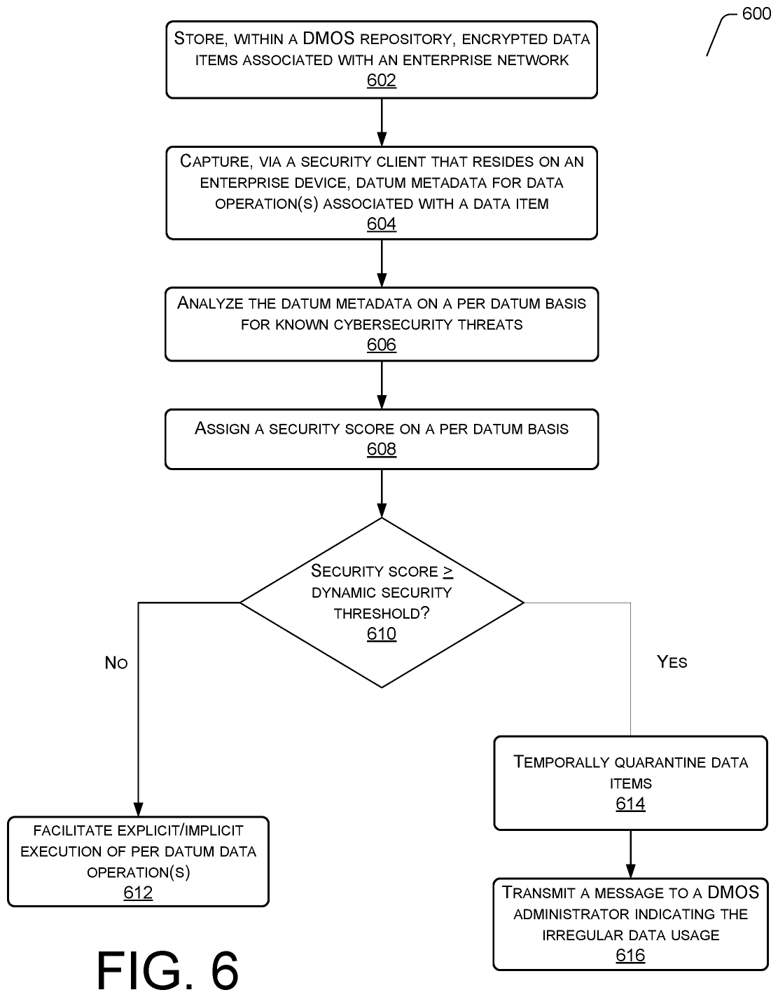

At 516, the DMOS may selectively analyze the datum metadata on a per datum (i.e. per data item) to infer whether a data operation may be part of a cybersecurity threat. The process for analyzing the datum metadata for cybersecurity threats is described in more detail with reference to FIG. 6.

FIG. 6 illustrates a process 600 for determining whether a data operation initiated at an enterprise device is part of a cybersecurity threat. In various examples, process 600 may occur in response to determining that a data operation is atypical, as determined via process 500. Alternatively, process 600 may occur concurrently with, and independent of, the data usage analysis of process 500.

At 602, the DMOS analysis server may store, within a data repository server, encrypted data items accessible within an enterprise network. The data items may be encrypted using cryptographic keys derived from a key management system employing industry best practices for key generation. Similarly, the encrypted data items may be decrypted using counterpart cryptographic keys, which are made available to enterprise devices that are afforded privileged access. The cryptographic keys may be accessible via a global key server that is communicatively connected to the DMOS analysis server. The global key server and the DMOS repository server may reside on disparate servers such that an unauthorized access of one would not compromise the other, and by extension, an unauthorized access would not compromise the availability, integrity, and confidentiality of the encrypted data items.

At 604, the DMOS analysis server may capture datum metadata from a security client that resides on an enterprise device. The datum metadata may describe individual instances of data operations, on a per datum basis, initiated at the enterprise device. The datum metadata may further include a user identifier of a user interacting with the enterprise device, a geolocation of the enterprise device at a point in time that a data operation is initiated, or a network segment identifier of the enterprise network from which the enterprise device initiated the interaction (i.e. data operation) with the data item.

At 606, the DMOS analysis server may employ one or more trained machine-learning algorithms to analyze the datum metadata relative to a dataset of known cybersecurity threats. More specifically, the DMOS analysis server may employ one or more trained machine learning algorithms to correlate the datum metadata 124 with data points of the dataset of known cybersecurity threats.

At 608, the DMOS analysis server may assign a security score on a per datum basis (i.e. per data item) based at least in part on analysis of the datum metadata. The DMOS analysis server may assign a security score to individual data operations on a per datum basis, such as an API call of a data item or a system call of the data item. Alternatively, the DMOS analysis server may assign a security score to an aggregate of data operations which are functionally related on a per datum basis. For example, the DMOS analysis server may assign a security score to a data item based on an API call to access a data item and a concurrent system call to initiate access to the data item. If the API call is configured to request read access to the data item and the concurrent system call is configured to delete the data item, the DMOS analysis server may infer that a cybersecurity threat is likely, and accordingly, assign a security score that reflects the same.

At 610, the DMOS analysis server may determine whether the data operations associated with the data item are likely to be part of a cybersecurity threat. In this process step, the DMOS analysis server may compare the security score with a dynamic security threshold. The dynamic security threshold may be set by an administrator of the DMOS analysis server or enterprise network as a function of the dataset of known cybersecurity threats. In other words, as the dataset of known cybersecurity threats develops over a predetermined time interval, so too does the dynamic security threshold. The dynamic security threshold may represent a security score above which the DMOS analysis server may infer the presence of a cybersecurity threat.

At 612, the DMOS analysis server may determine that the security score is less than the dynamic security threshold. Accordingly, the DMOS analysis server may infer that data operations associated with the data item, and as described within the datum metadata, is unlikely to be part of a cybersecurity threat.

In doing so, the DMOS analysis server may facilitate an explicit/implicit execution of the data operation associated with the data item. In one example, the data item may be encrypted. Therefore, the DMOS analysis server may interact with a global key server to provision a cryptographic key to the enterprise device to decrypt and access the data item. An explicit execution may correspond to providing the cryptographic key to the enterprise device, whereas an implicit execution may correspond to not blocking an act to provide the cryptographic key to the enterprise device.

At 614, the DMOS analysis server may determine that the security score is greater than the dynamic security threshold. At this process step, the DMOS analysis server may infer that the data operation(s) associated with the data item present a cybersecurity threat to the enterprise network.

In doing so, the DMOS analysis server may temporally quarantine the data item associated with the data operation. In one example, the DMOS analysis server may generate instructions for the global key server to withhold provisioning of a cryptographic key required to decrypt the encrypted data item. Alternatively, the response protocol may instruct the global key server to alter access privileges associated with the data item to ensure that the enterprise device is no longer provisioned with a cryptographic key to access the data item. Further, the DMOS analysis server, or global key server, may transmit a message to the enterprise device indicating that the data item has been temporally quarantined based on an inferred cybersecurity threat. Additionally, in the event that the response protocol restricts the enterprise device from a segment of the enterprise network, or from substantially all of the enterprise network, the message sent to the enterprise device may be configured to indicate the same.

At 616, the DMOS analysis server may transmit a message to an administrator of the DMOS analysis server or enterprise network that describes the data operation(s) associated with the data item. The message may further include one or more selectable options to permit execution of the data operation(s) or terminate execution of the data operation(s).

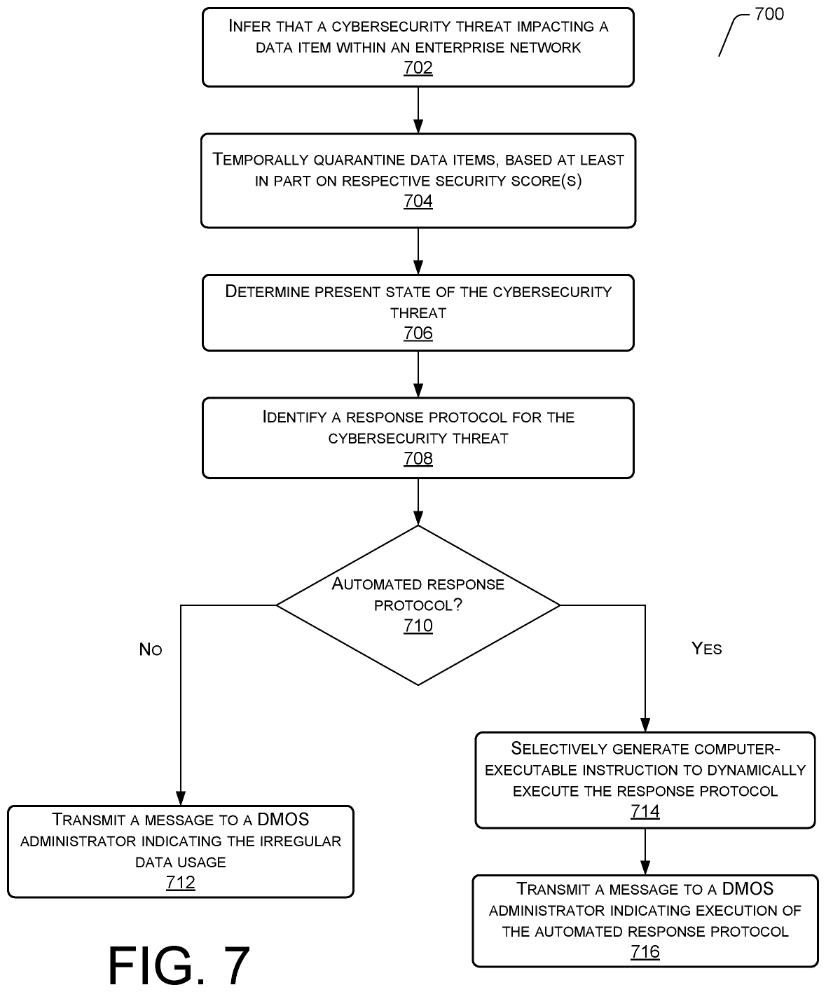

FIG. 7 illustrates a process 700 for generating a response protocol for a cybersecurity threat impacting an enterprise network. The DMOS analysis server may infer that a cybersecurity threat impacts a data item, and in doing so, further determine the state of the cybersecurity threat, namely whether the cybersecurity threat has been deployed, is currently being deployed, or is yet to be deployed. Accordingly, the DMOS analysis server may identify and execute a response protocol based on the present state of the cybersecurity threat.

At 702, the DMOS analysis server may infer that a cybersecurity threat is impacting a data item within an enterprise network. The inference of a cybersecurity threat may be based on execution of process 600.

At 704, the DMOS analysis server may temporally quarantine the data item associated with the cybersecurity threat. In one example, a quarantine may be enabled by withholding a cryptographic key(s) 116 required to access the data item. Alternatively, the DMOS analysis server may alter access privileges associated with the data item to restrict the data item access to administrators of the enterprise network.

At 706, the DMOS analysis server may determine a present state of the cybersecurity threat, namely whether the cybersecurity threat has been deployed, is currently being deployed or is yet to be deployed. The DMOS analysis server may determine the present state of the cybersecurity threat based on analysis of datum metadata relative to a dataset of known cybersecurity threats.

In various examples, the dataset of known cybersecurity threats may include indicators of each state (i.e. lapsed, current, or impending) of a cybersecurity threat, such that the DMOS analysis server may infer, via analysis, the present state of a cybersecurity threat within the enterprise network.

At 708, the DMOS analysis server may identify a response protocol for the cybersecurity threat, based at least in part on its present state within the enterprise network. In one example, the response protocol may involve modifying access privileges to a data item that effectively quarantines the data item from the enterprise network. Access privileges associated with a data item may be data item specific, user-specific, or application-specific, or any combination thereof. Therefore, a quarantine may be implemented by modifying the access privileges.

In another example, the response protocol may involve isolating a particular enterprise device from the enterprise network. In yet another example, the response protocol may involve isolating a particular network segment of the enterprise network from remaining portions of the enterprise network.

At 710, the DMOS analysis server may determine whether the response protocol may be automated. In various examples, the DMOS analysis server may include, within a data store, a set of automated response protocols that can be dynamically executed in response to detecting a cybersecurity threat.

At 712, the DMOS analysis server may determine that an automated response protocol is not available for the cybersecurity threat. Therefore, the DMOS analysis server may generate a message for delivery to an administrator of the DMOS analysis server that identifies the inferred cybersecurity threat. In some examples, the message may further include a recommended response protocol. In other examples, the message may identify the cybersecurity threat and state that further investigation is necessary.

At 714, the DMOS analysis server may determine that an automated response protocol is available for the cybersecurity threat. Accordingly, the DMOS analysis server may generate computer-executable instructions that dynamically execute the automated response protocol in real-time or near real-time.

At 716, the DMOS analysis server may generate a message for delivery to an administrator of the DMOS analysis server that indicates execution of the automated response protocol. In some examples, the message may further include selectable options to permit the administrator to cancel or reverse execution of the automated response protocol.

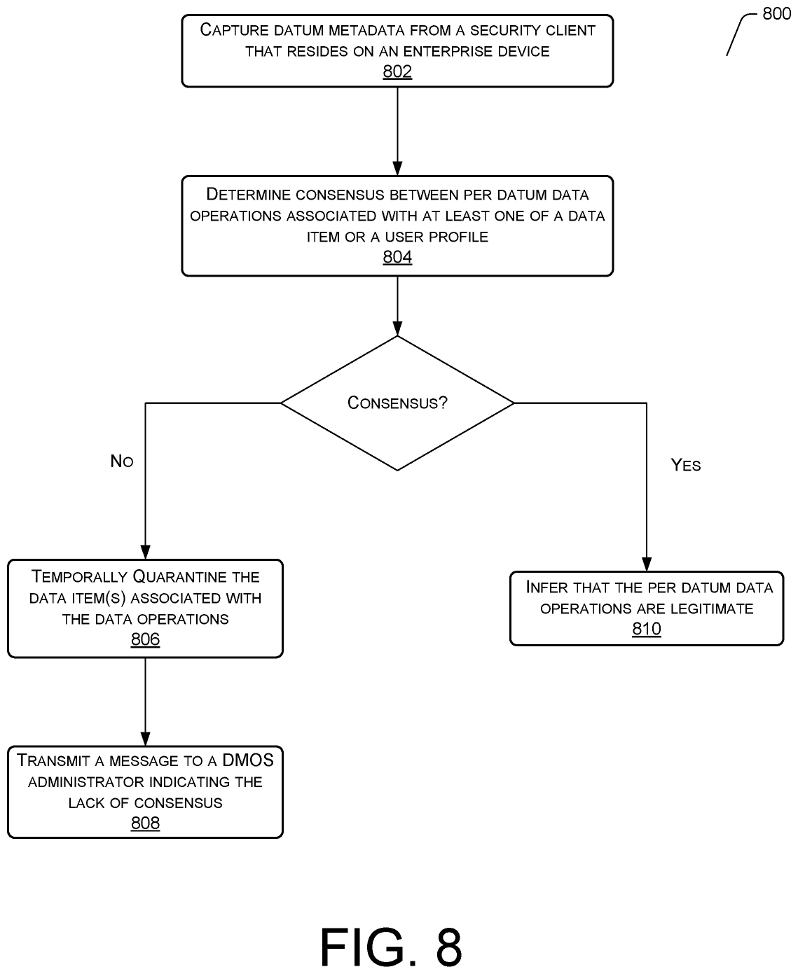

FIG. 8 illustrates a process 800 for inferring a cybersecurity threat based on a consensus of data operation(s) associated with a data item. In some examples, the datum metadata may include multiple data operations which are functionally related on a per datum basis. For example, an API call may be configured to request read access to a data item, and a system call may be configured to access the data time. In some examples, the DMOS analysis server may infer a likely presence of a cybersecurity threat, based on a lack of consensus between the functionally related data operation(s) of the data item. For example, if the API call is configured to request read access to the data item, and the system call is configured to delete the data item, the lack of consensus may form the basis for inferring the likely presence of a cybersecurity threat.

At 802, the DMOS analysis server may capture datum metadata from a security client that resides on an enterprise device. The DMOS analysis server may further analyze the datum metadata to identify multiple data operations which are functionally related on a per datum basis (i.e. per data item). The multiple data operations may include an API call to access a data item and a concurrent, or near-concurrent, system call to initiate access to the data item.

At 804, the DMOS analysis server may determine whether there is a consensus between the multiple data operations associated with a data item. For example, the datum metadata may describe an API call that is configured to request access to a data item and a concurrent system call to initiate access to the data item. Alternatively, the datum metadata may describe an API call that is configured to request access to a data item and a concurrent system call that is configured to delete data items, which may or may not include the particular data item.

At 806, the DMOS analysis server may determine that there is a lack of consensus between the multiple data operations. For example, an API call to request access to a data item is not consistent with a system call to delete a set of data items, which may or may not include the data item.

In doing so, the DMOS analysis server may temporally quarantine the data item associated with the data operation. In one example, the DMOS analysis server may generate instructions for the global key server to withhold provisioning of a cryptographic key required to decrypt the encrypted data item. Alternatively, the response protocol may instruct the global key server to alter access privileges associated with the data item to ensure that the enterprise device is no longer provisioned a cryptographic key to access the data item.

At 808, the DMOS analysis server may transmit a message to an administrator of the DMOS analysis server or enterprise network that describes the lack of consensus between data operation(s). The message may further include one or more selectable options to permit or terminate execution of the data operation(s). Alternatively, the DMOS analysis server may dynamically terminate the data operation(s) by withholding the provisioning of a cryptographic key required to access the data item or altering access privileges associated with the data item.

At 810, the DMOS analysis server may determine that there is a consensus between the multiple data operations. For example, an API call to request access to a data item is consistent with a concurrent, or near-concurrent system call to access the data item.

In doing so, the DMOS analysis server may facilitate execution of the data operation(s) associated with the data item. In one example, the data item may be encrypted. Therefore, the DMOS analysis server may interact with a global key server to provision a cryptographic key to the enterprise device to decrypt and access the data item.

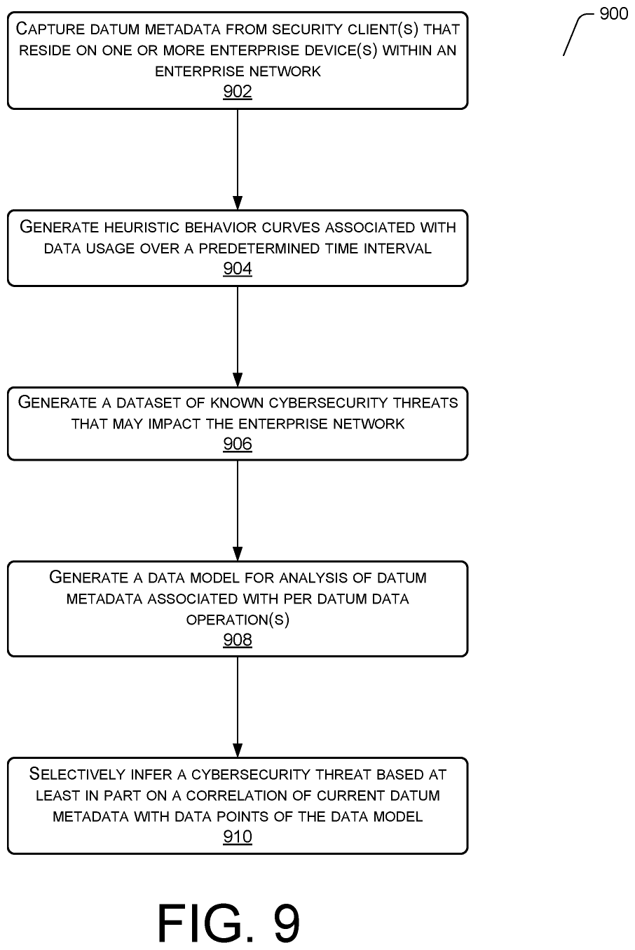

FIG. 9 illustrates a process 900 for generating a cybersecurity threat data model for analysis of datum metadata of data operation(s) executed at an enterprise device. The cybersecurity threat data model may be based on a multi-dimensional dataset that correlates datasets of known cybersecurity threats along with the set of heuristic behavior curves that exemplify a baseline of data usage within the enterprise network.

Since the DMOS analysis server can monitor operations of substantially all enterprise device(s) within an enterprise network on a per datum basis, the data item usage curves may also include behavioral data that is enterprise device-specific (i.e. user-specific). For example, the data item usage curves may indicate whether users of specific enterprise devices tend to open email attachments without much thought, or a certain class of purchases users tend to make.

At 902, the DMOS analysis server may capture datum metadata from security clients that reside on one or more enterprise device(s) within an enterprise network over a predetermined time interval. The datum metadata may identify multiple data operations initiated at an enterprise device that relate to data items stored within the enterprise network (i.e. data repository server). Multiple data operations may include an API call to access a data item and a concurrent, or near-concurrent, system call to initiate access to the data item.

At 904, the DMOS analysis server may generate data access usage curves indicative of data usage over the predetermined time interval, based at least in part on the datum metadata. The data access usage curves may describe data access patterns within the enterprise network over the predetermined time interval. Data access patterns may relate to various activities, such as creating, reading, updating, and deleting (i.e. CRUD) data items over the predetermined interval, by various actors (i.e. enterprise devices), and on a per datum basis.

The set of heuristic behavior curves generate a baseline of expected data usage, whereupon current data usage events may be analyzed. By way of example, consider an enterprise that periodically conducts a system backup. Data usage curves may be developed to reflect expected data usage for instances of the system backup on a per datum basis. If, however, on one occasion, the system backup was performed in an unexpected manner or generated unexpected results, the DMOS analysis server may identify the irregularity by a correlating data usage of the irregular event with the set of heuristic behavior curves, which reflect expected system backup performance.

In another example, a rapid number of encryptions that are statistically dissimilar to the baseline of expected data usage may suggest that a ransomware attack is underway. In this instance, the set of heuristic behavior curves may be used to trigger a remedial protocol that automatically stops encryption until an administrator investigates the occurrence.

At 906, the DMOS analysis server may develop a dataset of known cybersecurity threats based on historical interactions of cybersecurity threats within the enterprise network over a predetermined time interval. Additionally, or alternatively, the data may be imported from third-party entities that are knowledgeable in known cybersecurity threat data. Accordingly, the dataset of known cybersecurity threats may correspond to an amalgamation of developed data and imported data.

At 908, the DMOS analysis server may use one or more trained machine-learning algorithms to generate a cybersecurity threat data model for analysis of datum metadata of data operation(s) executed at an enterprise device. The cybersecurity threat data model may include the set of heuristic behavior curves described in process 500 and the dataset of known cybersecurity threats described in process 600. Accordingly, the cybersecurity threat data model may be configured to determine whether behavioral activities directed towards a data item and performed at an enterprise device are consistent with baseline expectations (i.e. set of heuristic behavior curves) and whether data operations on a per datum basis reflect an intrusion or pending intrusion of a cybersecurity threat.

At 910, the DMOS analysis server may interrogate the cybersecurity threat data model to generate new rules to detect cybersecurity threats. For example, if through interrogation of the cybersecurity threat data model, a data pattern can be discerned that has not been previously identified, the pattern may be used to generate a new rule to detect cybersecurity threats within the enterprise network. Similarly, pattern detection may relate to portions of an enterprise network that are prone to attack, and by whom.

In one example, the new rule may reflect new criteria for assigning a security score to a data item, in other words, a new pattern that corroborates the concurrent occurrence of data operations on a per datum basis, with a cybersecurity threat. In another example, the new rule may relate to configuring a monitoring operation (i.e. capturing datum metadata) of the enterprise network. For example, while a default condition may require monitoring of all data operations on a per datum basis, the DMOS analysis server may establish a new rule based on interrogating the cybersecurity threat data model, to selectively monitor a subset of data items rather than substantially all data items. The monitoring activity may specify particular data operations on a per datum basis, such as API calls and system calls.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed:

1. A system comprising:
one or more processors;
memory coupled to the one or more processors, the memory including one or more modules that are executable by the one or more processors to:
capture, via a security client that resides on an enterprise device, datum metadata associated with a data operation initiated by the enterprise device, the data operation being associated with a data item stored within a data repository server of an enterprise network;
analyze the datum metadata to determine whether the data operation is associated with a cybersecurity threat;
determine whether to facilitate an execution of the data operation, based at least in part on analysis of the datum metadata; and
generate a response protocol for delivery to a global key server, based at least in part on determining whether to facilitate the execution of the data operation.

2. The system of claim 1, wherein to analyze the datum metadata further includes determining a usage behavioral score based at least in part on a correlation of the datum metadata relative to a set of heuristic behavior curves, and
wherein to determine whether to facilitate the execution of the data operation is further based at least in part on a comparison of the usage behavior score relative to a dynamic usage threshold.

3. The system of claim 2, wherein the one or more modules are further executable by the one or more processors to:
generate the set of heuristic behavior that reflect at least one of a first set of historical interactions of the enterprise device with a set of data items stored with the data repository server of the enterprise network, or a second set of historical interactions of the set of data items with one or more enterprise devices associated with the enterprise network.

4. The system of claim 1, wherein to analyze the datum metadata further includes determining a security score based at least in part on a correlation of the datum metadata relative to a dataset of known cybersecurity threats, and
wherein, to determine whether to facilitate the execution of the data operation is further based at least in part on a comparison of the security score relative to a dynamic security threshold.

5. The system of claim 1, wherein the one or more modules are further executable by the one or more processors to:
retrieve a set of heuristic behavior curves and a dataset of known cybersecurity threats; and
generate, via one or more trained machine-learning algorithms, a data model to infer whether the cybersecurity threat impacts the enterprise network, and
wherein, to analyze the datum metadata includes correlating the datum metadata with data points of the data model.

6. The system of claim 1, wherein the one or more modules are further executable by the one or more processors to:
determine whether the datum metadata includes a plurality of data operations which are functionally related to the data item, the plurality of data operations including at least an Application Programming Interface (API) call and a system call; and
in response to the datum metadata including the plurality of data operations which are functionally related to the data item, determine whether a consensus exists between the plurality of data operations, and
wherein to analyze the datum metadata further includes determining the consensus between the plurality of data operations.

7. The system of claim 1, wherein the data item is stored within the data repository server as an encrypted data item, and
wherein to generate the response protocol further includes generating computer-executable instructions that instruct the global key server to provide the enterprise device with a cryptographic key to decrypt the encrypted data item, based at least in part on a determination to facilitate the execution of the data operation.

8. The system of claim 1, wherein the data item is stored within the data repository server as an encrypted data item, and
wherein to generate the response protocol further includes generating computer-executable instructions that instruct the global key server to alter access privileges associated with one of the data item or enterprise device, based at least in part on a determination to withhold facilitating the execution of the data operation.

9. The system of claim 1, wherein the one or more modules are further executable by the one or more processors to:
generate a message for delivery to an administrator of the enterprise network, based at least in part on a determination to withhold facilitating the execution of the data operation, the message further including selectable options to permit execution of the data operation or terminate execution of the data operation.

10. The system of claim 1, wherein the data operation comprises a request to create, read, update or delete the data item stored within the data repository server, and
wherein, the data item comprises a multimedia stream, control messages, signal data, a data file, a data object, or an access privilege associated with the data item or the data object.

11. The system of claim 1, wherein the datum metadata includes at least one of information describing the data operation, a user identifier associated with a user interacting with the enterprise device, a geolocation of the enterprise device at a point in time that the data operation is initiated, or a network segment identifier of the enterprise network from which the enterprise device initiated the data operation.

12. A computer-implemented method, comprising:
under control of one or more processors:
capturing, via a security client that resides on an enterprise device, datum metadata associated with a data operation initiated by the enterprise device, the data operation being associated with a data item stored within a data repository server of an enterprise network;
analyzing, via one or more trained machine-learning algorithms, the datum metadata relative to a dataset of known cybersecurity threats;
determining whether to facilitate execution of the data operation based at least in part on analysis of the datum metadata; and
in response to determining that the data operation constitutes a cybersecurity threat, generating a response protocol for delivery to a global key server, the response protocol to modify an access privilege associated with the data item that restricts access of the enterprise device to the data item.

13. The computer-implemented method of claim 12, further comprising:
analyzing the datum metadata relative to a set of heuristic behavior curves to infer whether the data operation constitutes a typical interaction or an atypical interaction with the enterprise network; and
determining a usage behavior score, based at least in part on a correlation of the datum metadata relative to the set of heuristic behavior curves, and
wherein, determining whether the data operation constitutes the cybersecurity threat to the enterprise network is further based at least in part on comparing the usage behavior score relative to a dynamic usage threshold.

14. The computer-implemented method of claim 12, further comprising:
determining a security score, based at least in part on analysis of the datum metadata relative to the dataset of known cybersecurity threats; and
determining the data operation constitutes the cybersecurity threat based at least in part on the security score being greater than or equal to a dynamic security threshold.

15. The computer-implemented method of claim 14, wherein the dataset of known cybersecurity threats includes a first portion and a second portion, and further comprising:
importing, from third-party entities that are knowledgeable in cybersecurity threat data, the first portion of the dataset of known cybersecurity threats; and
generating the second portion of the dataset of known cybersecurity threats based on historical interactions of cybersecurity threats within the enterprise network over a predetermined time interval.

16. The computer-implemented method of claim 14, further comprising:
determining that the datum metadata includes a plurality of data operations which are functionally related to the data item, the plurality of data operations including at least an API call and a system call; and
determining whether a consensus exists between the plurality of data operations, and
wherein, analyzing the datum metadata further includes determining the consensus between the plurality of data operations.

17. The computer-implemented method of claim 12, wherein the response protocol is further configured to modify access privileges of the enterprise device to the enterprise network, based at least in part on the analysis of the datum metadata.

18. An enterprise device, storing computer-executable instructions that, when executed on one or more processors, cause the one or more processors to perform acts comprising:
receiving, via a user interaction, a request to initiate a data operation with a data item associated with an enterprise network, the data item being stored as an encrypted data item within a data repository server;
intercepting, via a security client, the request to initiate the data operation prior to delivery to an operating system;
generating, at the security client, datum metadata associated with the request to initiate the data operation with the data item;
transmitting, the datum metadata to a DMOS analysis server, the DMOS analysis server to infer whether the data operation constitutes a cybersecurity threat to the enterprise network; and
in response to an inference that the data operation constitutes the cybersecurity threat, receiving, from one of the DMOS analysis server or a global key server associated with the enterprise network, a message indicating that the data item has been temporally quarantined, based at least in part on an inferred cybersecurity threat.

19. The enterprise device of claim 18, further comprising:
in response to an inference that the data operation does not constitute the cybersecurity threat, receiving, from the global key server, a cryptographic key to decrypt the encrypted data item.

20. The enterprise device of claim 18, wherein the message further indicates that the enterprise device has been restricted to access to a segment of the enterprise network, based at least in part on the inferred cybersecurity threat.
